(19) United States
(12) Patent Application Publication
(10) Pub. No.: US 2008/0143263 A1
(43) Pub. Date: Jun. 19, 2008

(54) Surface light source device and backlight unit having the same

(75) Inventors: Keun Seok Lee, Suwon-si (KR); Kyeong Taek Jung, Suwon-si (KR); Ki Yeon Lee, Suwon-si (KR); Hyung Bin Youn, Suwon-si (KR); Seok Mo Ban, Suwon-si (KR); Kyeong Taek Song, Suwon-si (KR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Samsung Corning Co., Ltd., Suwon-si (KR)

(21) Appl. No.: 11/999,255

(22) Filed: Dec. 4, 2007

(30) Foreign Application Priority Data
Dec. 11, 2006 (KR) 10-2006-0125712

(51) Int. Cl. G09G 3/06

(52) U.S. Cl. 315/169.1

(57) ABSTRACT

There is provided a surface light source device comprising: a light source body including a plurality of discharge spaces therein, a first electrode and a second electrode applying a first voltage into the discharge spaces and arranged parallel to each other, and a third electrode applying a second voltage into the discharge spaces and facing the first and second electrodes and arranged in a direction of crossing the first and second electrodes. In accordance with the present invention, the discharge firing voltage and sustain voltage of the surface light source device can be lowered by applying the first and second voltage to the electrodes. Further, it is possible to divisionally drive the surface light source device by sequentially and/or selectively applying a voltage to divided parts of each electrode.

### CROSS-REFERENCE TO RELATED APPLICATION

This application claims the benefit of Korean Patent Application No. 2006-0125712, filed Dec. 11, 2007, the disclosure of which is hereby incorporated herein by reference in its entirety.

### BACKGROUND OF THE INVENTION

1. Technical Field

The present invention relates to a surface light source device, and more particularly, to a surface light source device which comprises a first electrode and a second electrode arranged parallel to each other, and a third electrode facing the first and second electrodes and arranged in a direction of crossing the first and second electrodes, and a backlight unit having the surface light source device.

2. Discussion of Related Art

A liquid crystal display (LCD) device displays an image, using an electrical characteristic and an optical characteristic of liquid crystal. Since the LCD device is very small in size and light in weight, compared to a cathode-ray tube (CRT) device, it is widely used for portable computers, communication devices, liquid crystal television (LCTV) receivers, aerospace industry, and the like.

The LCD device includes a liquid crystal controlling part for controlling the liquid crystal, and a backlight source for supplying light to the liquid crystal. The liquid crystal controlling part includes a number of pixel electrodes disposed on a first substrate, a single common electrode disposed on a second substrate, and liquid crystal interposed between the pixel electrodes and the common electrode. The number of pixel electrodes corresponds to resolution, and the single common electrode is placed in opposite to the pixel electrodes. Each pixel electrode is connected to a thin film transistor (TFT) so that each different pixel voltage is applied to the pixel electrode. An equal level of a reference voltage is applied to the common electrode. The pixel electrodes and the common electrode are made of a transparent conductive material.

The light supplied from the backlight source passes through the pixel electrodes, the liquid crystal and the common electrode sequentially. The display quality of an image passing through the liquid crystal significantly depends on luminance and luminance uniformity of the backlight source. Generally, as the luminance and luminance uniformity are high, the display quality is improved. In a conventional LCD device, the backlight source generally uses a cold cathode fluorescent lamp (CCFL) in a bar shape or a light emitting diode (LED) in a dot shape. The CCFL has high luminance and long life of use and generates a small amount of heat, compared to an incandescent lamp. The LED has high consumption of power but has high luminance. However, in the CCFL or LED, the luminance uniformity is weak. Therefore, to increase the luminance uniformity, the backlight source, which uses the CCFL or LED as a light source, needs optical members, such as a light guide panel (LGP), a diffusion member and a prism sheet. Consequently, the LCD device using the CCFL or LED becomes large in size and heavy in weight due to the optical members.

Therefore, a surface light source device in a flat shape has been suggested as the light source of the LCD device.

Referring to FIG. 1, a conventional surface light source device 100 includes a light source body 110 and an electrode 160 provided at lateral edges of the light source body 110. The light source body 110 includes a first substrate and a second substrate which are spaced apart from each other by a predetermined distance. A plurality of partitions 140 are arranged between the first and second substrates, and partition an inner space defined by the first and second substrates into a plurality of discharge channels 120. Between the edges of the first and second substrates, a sealant (not shown) is disposed to isolate the discharge channels 120 from the outside. A discharge gas is injected into a discharge space 150 inside each discharge channel.

To drive the surface light source device, electrodes are formed on both or any one of the first and second substrates, and the electrode has a strip shape or an island shape to have the same area per discharge channel. When the surface light source device is driven by an inverter, all the discharge spaces are uniformly discharged.

An ordinary surface light source device maintains the constant luminance while it is driven. Although there has been proposed a technology of dimming the whole luminance of the surface light source device according to the video signal information of the liquid crystal display device, a technology of dimming the local luminance has not yet been provided.

To improve the image quality of a large-size liquid crystal display device and realize clearer and more natural display quality, the technology of locally dimming the luminance of the surface light source device is needed.

The surface light source device requires a high firing voltage on the starting of discharge and consumes high power while it is driven. Therefore, a new surface light source device needs to reduce a firing voltage and power consumption (that is, a sustain voltage).

### SUMMARY OF THE INVENTION

Therefore, the present invention is directed to provide a new surface light source device which is proper for a large-size surface light source device.

Another object of the present invention is to provide a surface light source device which reduces a firing voltage and a sustain voltage.

Another object of the present invention is to provide a surface light source device and a backlight unit which are able to locally dim its luminance.

In accordance with an aspect of the present invention, the present invention provides a surface light source device which comprises: a light source body including a plurality of discharge spaces; a first electrode and a second electrode applying a first voltage into the discharge spaces and arranged parallel to each other; and a third electrode applying a second voltage into the discharge spaces and facing the first and second electrodes and arranged in a direction of crossing the first and second electrodes.

The first, second and third electrodes may be formed on an inner surface or an outer surface of the light source body. The second voltage applied by the third electrode may be lower or higher than the first voltage applied by the first and second electrodes.

The light source body may include a first substrate and a second substrate. Preferably, the first and second electrodes may be formed on any one of the first and seconds substrates and the third electrode may be formed on the other substrate.

In accordance with another aspect of the present invention, the present invention provides a backlight unit which comprises: a surface light source device which comprises a light source body including a plurality of discharge spaces, a first electrode and a second electrode applying a first voltage into the discharge spaces and arranged parallel to each other, and a third electrode applying a second voltage into the discharge spaces and facing the first and second electrodes and arranged in a direction of crossing the first and second electrodes; a case receiving the surface light source device; and an inverter supplying the discharge voltages to the electrodes.

The surface light source device and the backlight unit according to the present invention reduce a firing voltage and a sustain voltage. Further, it is possible to divisionally drive the surface light source device by sequentially and/or selectively applying a voltage to divided parts of each electrode, and thereby to realize scan dimming or local dimming of the surface light source device.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 is a perspective view of a conventional surface light source device;

FIGS. 2 and 3 are a plan view and a bottom view of a surface light source device according to an embodiment of the present invention;

FIG. 4 is sectional view taken along line IV-IV of the surface light source device of FIG. 2;

FIGS. 5 through 8 are sectional views of surface light source devices according to other embodiments of the present invention;

FIGS. 9 and 10 are a plan view and a bottom view of a surface light source device according to another embodiment of the present invention;

FIG. 11 is a sectional view taken along line XI-XI of the surface light source device of FIG. 9;

FIGS. 12 and 13 are sectional views of surface light source devices according to other embodiments of the present invention;

FIG. 14 is a plan view of a surface light source device according to another embodiment of the present invention;

FIGS. 15 and 16 are partial sectional view taken along lines XV-XV and XVI-XVI of the surface light source device of FIG. 14;

FIGS. 17 and 18 are perspective views of a surface light source device according to another embodiment of the present invention;

FIG. 19 is a sectional view taken along line XIX-XIX of the surface light source device of FIG. 17; and

FIG. 20 is an exploded perspective view of a backlight unit according to another embodiment of the present invention.

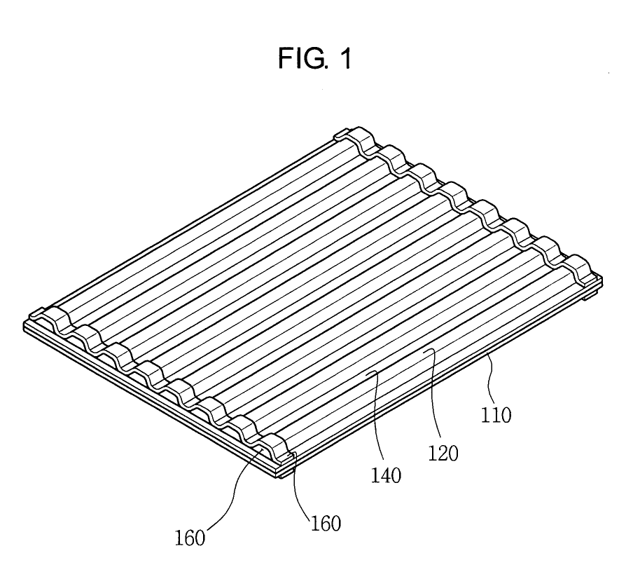

### DETAILED DESCRIPTION OF THE INVENTION

The present invention will now be described more fully hereinafter with reference to the accompanying drawings, in which preferred embodiments of the invention are shown.

The terminology used herein is for the purpose of describing a particular embodiment only and is not intended to limit the exemplary embodiment of the invention. The singular forms “a”, “an” and “the’ are intended to include the plural forms as well, unless the context clearly indicates otherwise.

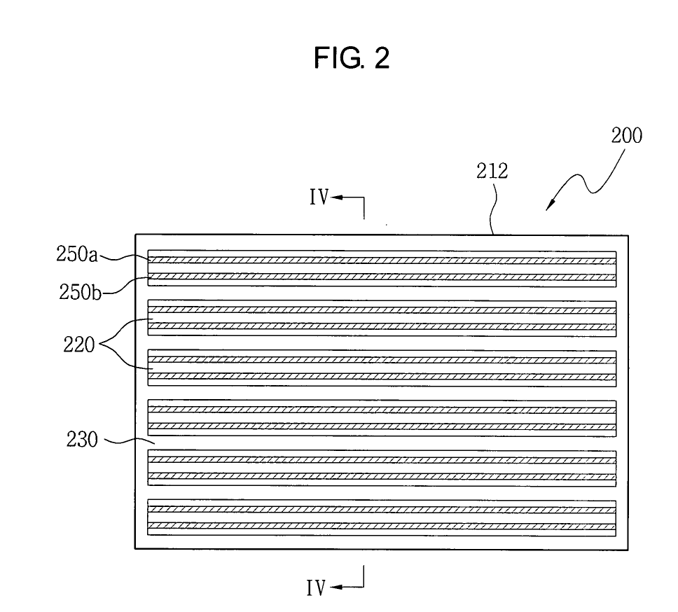

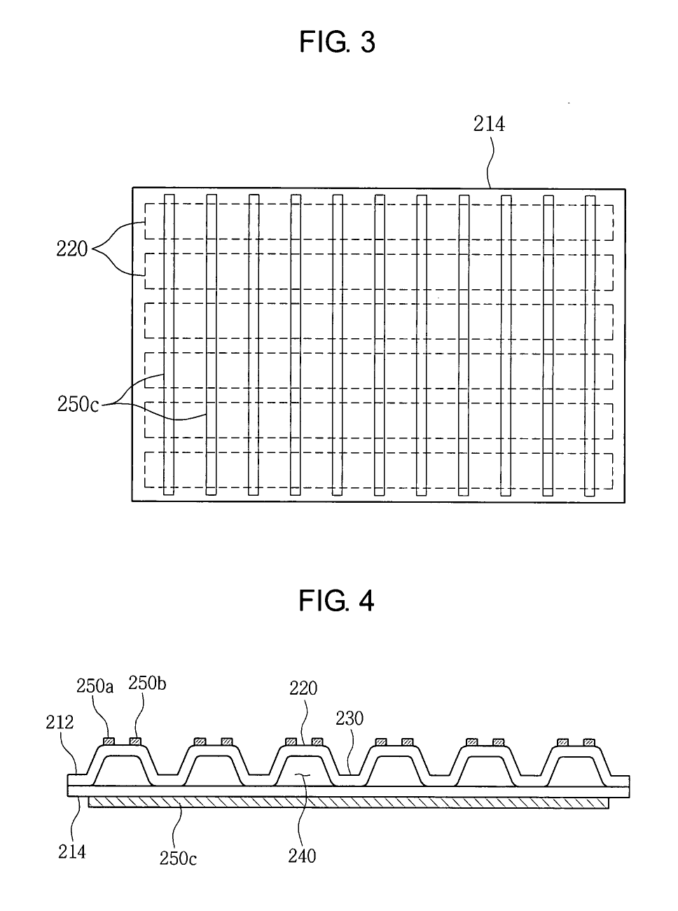

FIG. 2 is a plan view of a surface light source device 200 according to an embodiment of the present invention, and FIG. 3 is a bottom view of the surface light source device 200.

The surface light source device 200 comprises a first substrate 212 and a second substrate 214 as parts of a light source body. A plurality of discharge spaces 240 are formed between the first and second substrates. The discharge channels 220 may be formed by molding, for example, any one of the first and second substrates. The adjacent discharge channels are partitioned by a partition 230 which can not emit light.

According to the embodiment, a plurality of discharge channels elongated in one direction are formed on the first substrate 212. A first electrode 250a and a second electrode 250b are formed on the first substrate 213 where the discharge channels are formed. The first electrode 250a and the second electrode 250b are arranged parallel to each other along the discharge channels. A third electrode 250c is formed on the second substrate 214 where no discharge channels are formed. The third electrode 250c faces the first and second electrodes and is arranged in a direction of perpendicularly crossing the first and second electrodes. That is, the third electrode 250c perpendicularly crosses the first and second electrodes 250a and 250b on their projection plane.

The inner surfaces of the first substrate 212 and second substrate 214 may be coated with a fluorescent layer (not shown). A reflective layer (not shown) may be formed at any one of the first and second substrates. The edges of the first substrate 212 and the second substrate 214 may be bonded together by using a sealant, such as frit and the like, or may be melted to be directly joined by means of a heater, for example, a laser apparatus.

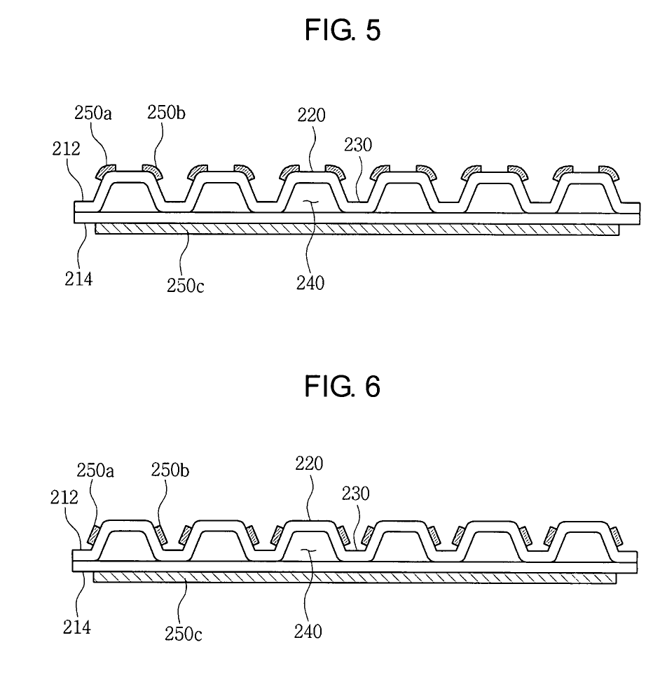

FIGS. 5 through 8 illustrate a modified surface light source device. The first electrode 250a and the second electrode 250b are positioned differently from the electrodes in FIG. 4. That is, the first electrode 250a and the second electrode 250b are disposed a top corner area of the discharge channel in FIG. 5 and on a lateral side area of the discharge channel in FIG. 6, while the first electrode 250a and the second electrode 250b are disposed on a top flat area in FIG. 4.

A sustain voltage may be applied to the first and second electrodes, to form a wall charge in a discharge space 240. In this case, an address voltage or a signal voltage may be applied to the third electrode, to start the discharge of a gas injected into the discharge space.

The surface light source device according to this embodiment of the present invention may apply a first voltage as the sustain voltage to the first and second electrodes and a second voltage as the address voltage lower than the first voltage to the third electrode. As described above, it is possible to lower the firing voltage and the sustain voltage for driving the surface light source device and thereby reduce power consumption by using the three electrodes.

The first and second electrodes are arranged in a direction of crossing the third electrode. Each electrode can be designed to be electrically divided into a plurality of divided parts and the voltage can be divisionally applied to the divided parts of each electrode. In this case, the surface light source device can be divisionally driven by sequentially and/or selectively applying the voltage to the divided parts of each electrode, which enable the scan dimming or the local dimming.

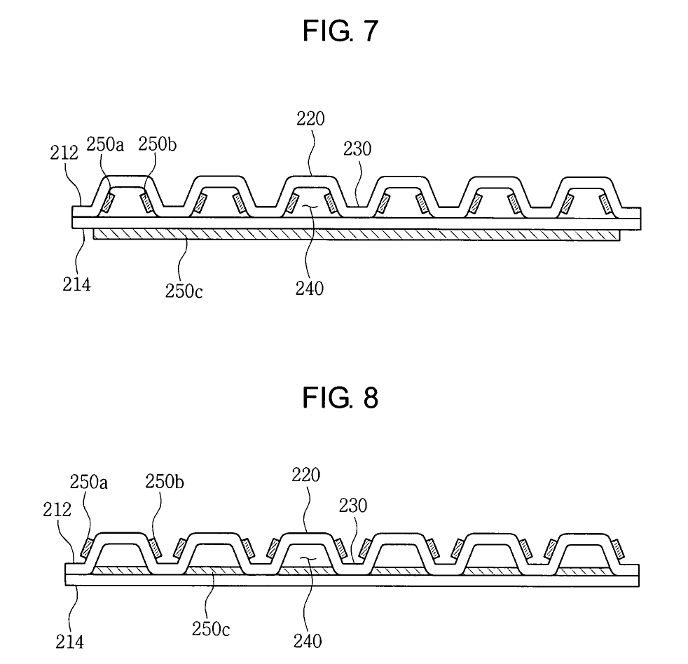

As illustrated in FIG. 7, the first electrode 250a and the second electrode 250b may be formed inside the first substrate. Further, as illustrated in FIG. 8, the third electrode 250c may be formed inside the second substrate. When the electrodes are formed inside the substrate, a dielectric layer (not shown) may be further formed to cover the electrodes, to prevent the electrodes from being damaged by the discharge in the discharge space.

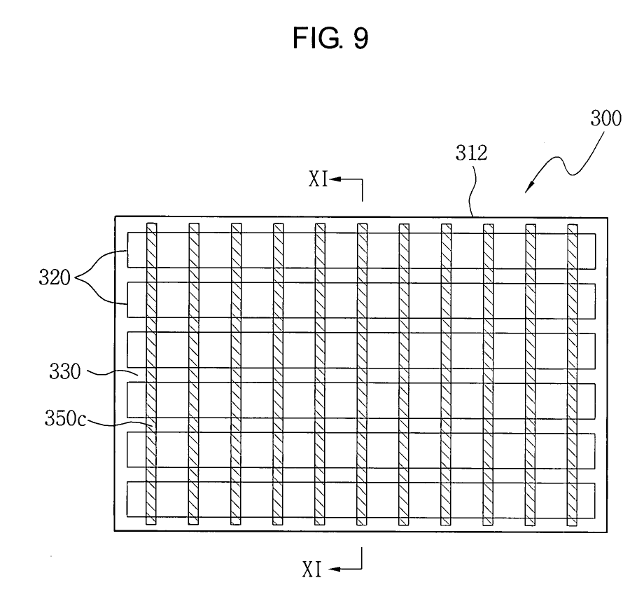

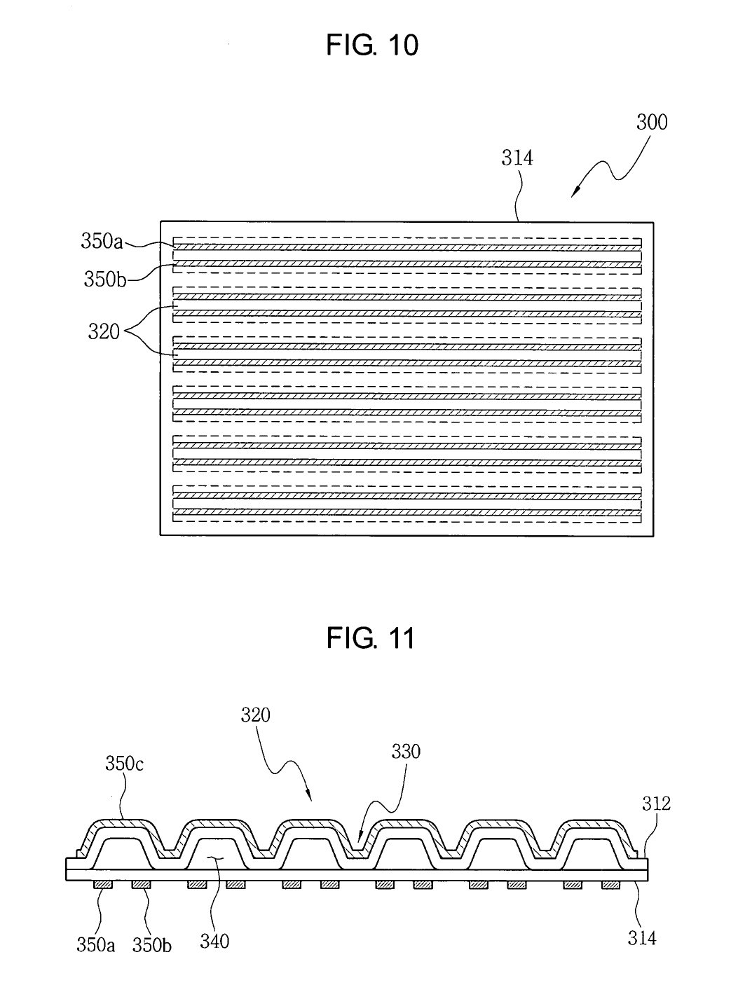

FIGS. 9 and 10 illustrate a plan view and a bottom view of a surface light source device 300 according to another embodiment of the present invention, in which a plurality of discharge channels 320 elongated in one direction are also formed on a first substrate 312.

Unlike the embodiment of FIG. 2, a third electrode 350c is formed on the first substrate 312 where the discharge channels are formed, to be perpendicular to the longitudinal direction of the discharge channels, and a first electrode 350a and a second electrode 350b are formed on a second substrate 314 where no discharge channels are formed, to be parallel to the longitudinal direction of the discharge channels.

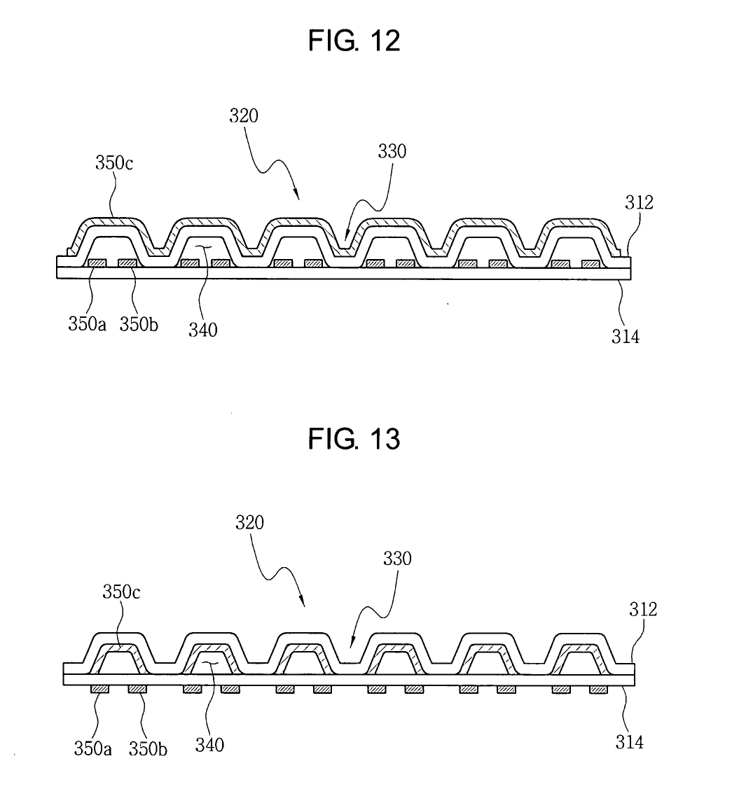

The first electrode 350a, the second electrode 350b and the third electrode 350c may be formed at an inner surface or an outer surface of the substrates as illustrated in FIGS. 11 through 13.

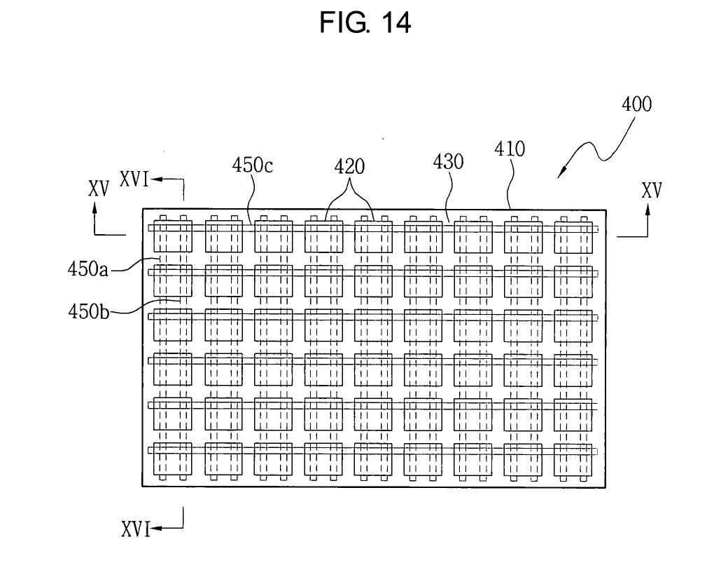

FIG. 14 illustrates a surface light source device 400 according to another embodiment of the present invention. A light source body 410 includes a first substrate 412 and a second substrate 414. A plurality of discharge cells 420 may be formed on at least one of the first and second substrates and may be disposed in a matrix form. In FIG. 14, the discharge cells 420 are formed on the first substrate 412, and each discharge cell is partitioned by a partition 430.

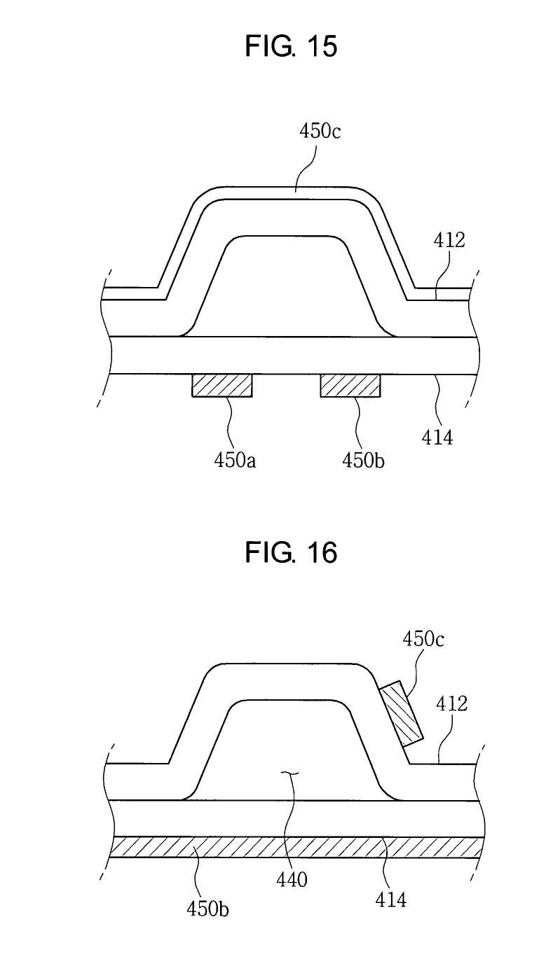

FIG. 15 illustrates a section of the discharge cell taken along XV-XV of FIG. 14. As illustrated in FIG. 15, a first electrode 450a and a second electrode 450b are arranged to be parallel to each other on an outer surface of the second substrate 414 where no discharge cells are formed. FIG. 16 illustrates the section of the discharge cell taken along line XVI-XVI of FIG. 14. As illustrated in FIG. 16, a third electrode 450c is formed perpendicular to the first and second electrodes on an outer surface of the first substrate 412 where the discharge cells are formed.

Alternatively, the first and second electrodes may be disposed to be parallel to each other on the first substrate, and the third electrode may be formed perpendicular to the first and second electrodes on the second substrate. Further, the first, second and third electrodes may be formed inside the substrates.

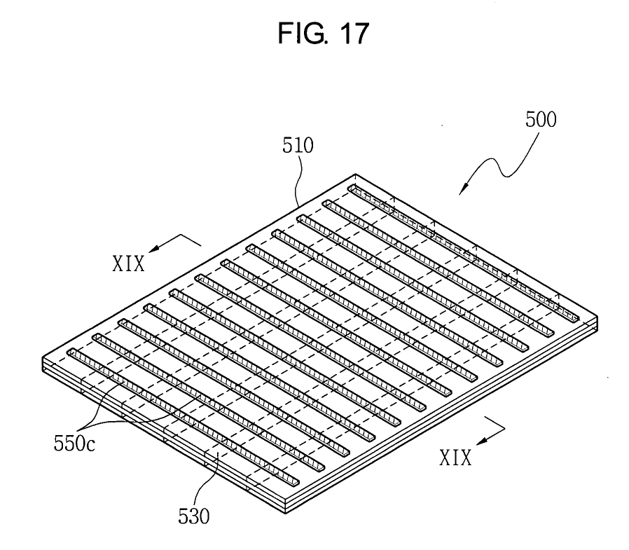

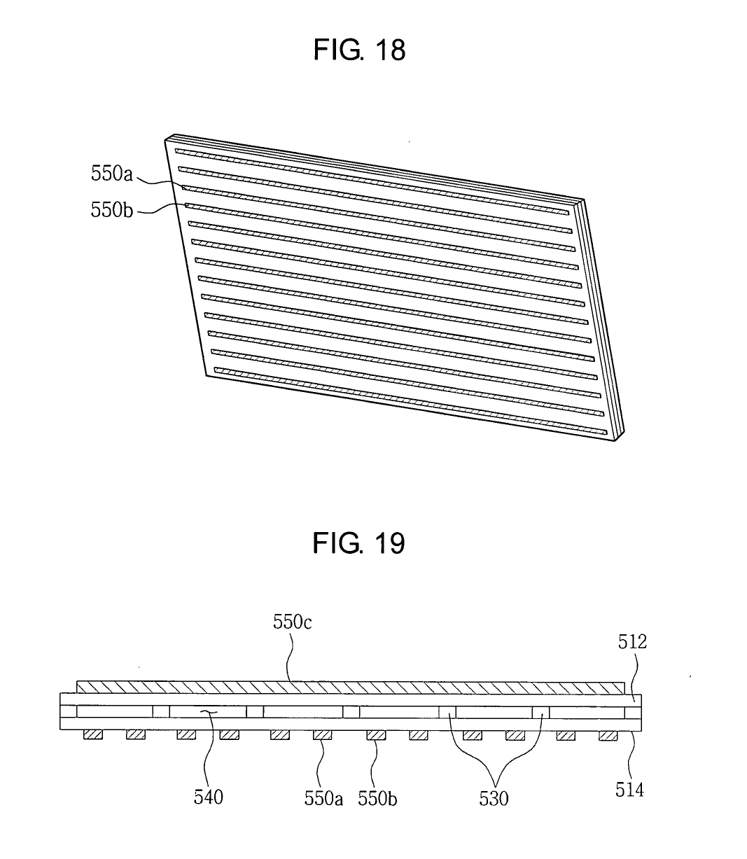

FIGS. 17 and 18 illustrate a surface light source device 400 according to another embodiment of the present invention. Unlike the aforementioned embodiments, a light source body 510 includes a flat first substrate 512 and a flat second substrate 514. The inner space between the first substrate 512 and the second substrate 514 is partitioned into a plurality of discharge spaces 540 by partitions 530. The surface light source device according to this embodiment can be manufactured to be ultra slim.

A third electrode 550c is formed on the first substrate 512, and a first electrode 550a and a second electrode 550b are formed on the second substrate 514, to correspond to each discharge channel and be perpendicular to the third electrode. Otherwise, the first and second electrodes may be formed on the first substrate and the third electrode may be formed on the second substrate.

In the present invention, the first, second or third electrode may be formed in, for example, a stripe pattern, a mesh pattern, or a tape pattern. Preferably, the electrode is made of a material with high transmittance of visible rays, so that light generated by the discharge may not hindered by the electrode.

Further, the first, second or third electrode may have a multilayer structure with a base layer, an electrode pattern formed on the base layer, and a protection layer formed on the electrode pattern. The multilayer structure enables the electrode to be easily bonded to the substrate, to secure durability of the electrode pattern, and to have the electrode pattern in diverse forms. The base layer may be made of a transparent polymer material which is durable against a thermal impact. The electrode pattern may be made of a material of high conductivity, such as copper, silver, gold, aluminum, nickel, chrome, carbon-basis or polymer-basis, or a mixture thereof. The protection layer may be made of a transparent polymer material which is durable against the thermal impact.

In the surface light source device according to a preferred embodiment of the present invention, since the distance between the electrodes is small, a gas which does not use a positive column, such as, for example, xenon, argon, neon, other inert gases and a mixture thereof. Therefore, a gas excluding mercury can be used as the discharge gas and thus, the surface light source device according to the preferred embodiment is environment-friendly. However, the present invention does not exclude the use of mercury as the discharge gas.

In the surface light source device according to the present invention, at least one electrode is formed in a perpendicular direction to the other electrode, and thus, a combination of the first to third electrodes has a grating shape. Therefore, each discharge space can be considered to be electrically divided into a plurality of sub-spaces and the voltage can be divisionally applied to each of the sub-spaces. Accordingly, in the present invention, the luminance can be divisionally controlled through scan dimming or local dimming.

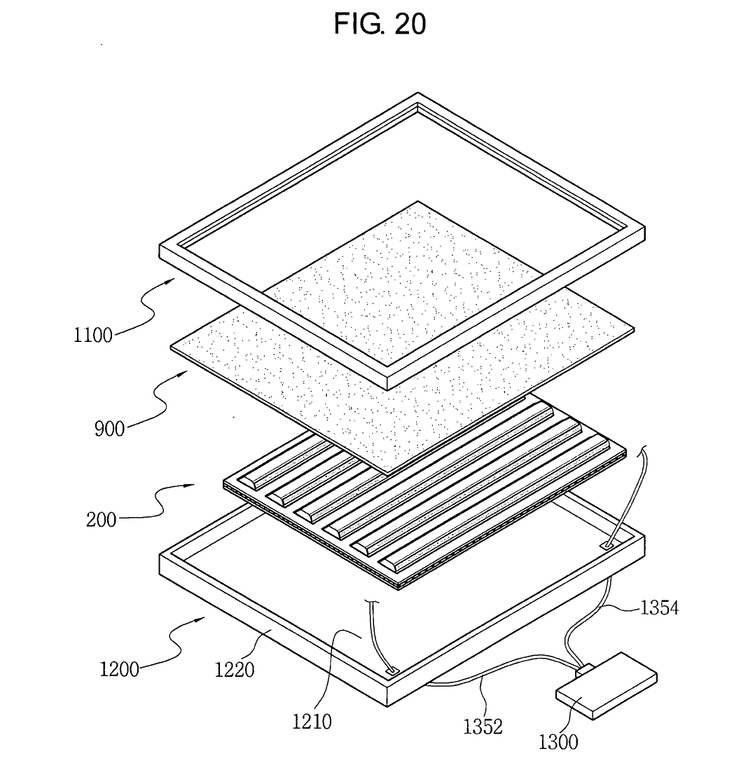

FIG. 20 is an exploded perspective view of a backlight unit including a surface light source device according to the present invention. As illustrated, the backlight unit comprises a surface light source device 200, an upper case 1100 and a lower case 1200, an optical sheet 900, and an inverter 1300. The lower case 1200 includes a bottom 1210 over which the surface light source device 200 is received and a plurality of sidewalls 1220 extending from edges of the bottom 1210 to receive the surface light source device.

The inverter 1300 may be positioned at the back side of the lower case 1200 and generates a discharge voltage to drive the surface light source device 200. The discharge voltage generated by the inverter 1300 is supplied to electrodes of the surface light source device 200. For example, the inverter 1300 supplies a first voltage to a first electrode and a second electrode and a second voltage lower than the first voltage to a third electrode, thereby decreasing a firing voltage and a sustain voltage.

The optical sheet 900 may include a diffusion plate to uniformly diffuse the light emitted from the surface light source device 200, and a prism sheet to make the diffused light go straight ahead. The upper case 1100 is coupled with the lower case 1200, to support the surface light source device 200 and the optical sheet 900. The upper case 1100 prevents the surface light source device 200 from being separated from the lower case 1200.

Unlike the drawing as illustrated, the upper case 1100 and the lower case 1200 may be formed in a single integrated case. However, since the luminance and the uniformity of luminance of the surface light source device are excellent, the backlight unit according to the present invention may not include the optical sheet 900.

In accordance with the present invention, the surface light source device and the backlight unit can lower the firing voltage and the sustain voltage. Further, the surface light source device can be divisionally driven by sequentially and/or selectively applying a voltage to divided parts of each electrode. The surface light source device according to the present invention can attain excellent optical performance through the scan dimming or local dimming.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed:

1. A surface light source device comprising:
a light source body including a plurality of discharge spaces therein;
a first electrode and a second electrode applying a first voltage into the discharge spaces and arranged parallel to each other; and
a third electrode applying a second voltage into the discharge spaces and facing the first and second electrodes and arranged in a direction of crossing the first and second electrodes.

2. The surface light source device of claim 1, wherein the first, second and third electrodes are formed on an inner surface or an outer surface of the light source body.

3. The surface light source device of claim 1, wherein the second voltage is lower than the first voltage.

4. The surface light source device of claim 1, wherein the light source body includes a first substrate and a second substrate, and the first and second electrodes are formed on any one of the first and second substrates and the third electrode is formed on the other substrate.

5. The surface light source device of claim 1, wherein the light source body includes the first substrate and the second substrate, and a plurality of discharge channels are formed on at least one of the first and second substrates and extend in one direction.

6. The surface light source device of claim 5, wherein the first and second electrodes are formed on an outer surface or an inner surface of the substrate where the discharge channels are formed.

7. The surface light source device of claim 5, wherein the third electrode is formed on an outer surface or an inner surface of the substrate where the discharge channels are formed.

8. The surface light source device of claim 1, wherein the light source body includes a first substrate and a second substrate, and a plurality of discharge cells are formed on at least one of the first and second substrates and are arranged in a matrix form.

9. The surface light source device of claim 8, wherein the first and second electrodes are formed on an outer surface or an inner surface of the substrate where the discharge cells are formed.

10. The surface light source device of claim 8, wherein the third electrode is formed on an outer surface or an inner surface of the substrate where the discharge cells are formed.

11. The surface light source device of claim 1, wherein the light source body includes a flat first substrate and a flat second substrate, and an inner space between the first and second substrates is partitioned into a plurality of discharge spaces by partitions.

12. The surface light source device of claim 11, wherein the first and second electrodes are formed on any one of the first and second substrates and the third electrode is formed on the other substrate.

13. The surface light source device of claim 1, wherein the first, second or third electrode is formed in a stripe pattern, a tape pattern, or a mesh pattern.

14. The surface light source device of claim 1, wherein the first, second, or third electrode includes a base layer, an electrode pattern formed on the base layer, and a protection layer formed on the electrode pattern.

15. The surface light source device of claim 1, wherein a discharge gas excluding mercury is in the discharge spaces.

16. A backlight unit comprising:
a surface light source device comprising:
a light source body including a plurality of discharge spaces therein,
a first electrode and a second electrode applying a first voltage into the discharge spaces and arranged parallel to each other, and
a third electrode applying a second voltage into the discharge spaces and facing the first and second electrodes and arranged in a direction of crossing the first and second electrodes;
a case receiving the surface light source device; and
an inverter supplying the discharge voltages to the electrodes.

17. The backlight unit of claim 16, wherein the inverter applies a first voltage to the first and second electrodes and applies a second voltage lower than the first voltage to the third electrode.

18. The backlight unit of claim 16, wherein the light source body includes a first substrate and a second substrate, and the first and second electrodes are formed on any one of the first and second substrates and the third electrode is formed on the other substrate.

19. The backlight unit of claim 16, wherein the light source body includes the first substrate and the second substrate, and a plurality of discharge channels are formed on at least one of the first and second substrates and extend in one direction.

20. The backlight unit of claim 16, wherein the light source body includes a first substrate and a second substrate, and a plurality of discharge cells are formed on at least one of the first and second substrates and are arranged in a matrix form.

21. The backlight unit of claim 16, wherein the light source body includes a flat first substrate and a flat second substrate, and an inner space between the first and second substrates is partitioned into the plurality of discharge spaces by partitions.
